(19) United States
(12) Patent Application Publication
(10) Pub. No.: US 2024/0344208 A1
(43) Pub. Date: Oct. 17, 2024

(54) Electrolyzer with a Stack of Welded Four-Layer Modules

(71) Applicant: Stiesdal Hydrogen A/S, Give (DK)

(72) Inventors: Henrik Stiesdal, Odense C (DK); Karsten Schibsbye, Fredericia (DK)

(21) Appl. No.: 18/676,660

(22) Filed: May 29, 2024

Related U.S. Application Data
(63) Continuation of application No. PCT/DK2022/050257, filed on Dec. 2, 2022.

(30) Foreign Application Priority Data
Dec. 7, 2021 (DK) PA 2021 01160

(51) Int. Cl. C25B 1/04; C25B 9/75; C25B 9/77; C25B 11/03; C25B 15/08

(52) U.S. Cl. CPC C25B 1/04; C25B 9/75; C25B 9/77; C25B 11/03; C25B 15/083

(57) ABSTRACT

Electrolyzer comprising modules that sandwich ion-transporting membranes in between adjacent modules. The modules are formed as four-layer structures of four metal plates, typically steel plates, including two separator plates combined into a BPP and an anode plate and a cathode plate respectively on opposite sides of the BPP. The four plates are welded together to form a rigid module with three separate compartments, one anode compartment, one cathode compartment and a coolant compartment.

### CROSS-REFERENCE TO RELATED APPLICATIONS

This application is a continuation under 35 U.S.C. 111 of International Patent Application No. PCT/DK2022/050257, filed Dec. 2, 2022, which claims the benefit of and priority to Danish Application No. PA 2021 01160, filed Dec. 7, 2021, each of which is hereby incorporated by reference in its entirety.

### FIELD OF INVENTION

The present systems and methods relate to an electrolyzer for production of hydrogen gas, the electrolyzer comprising a stack of modules sandwiching ion-transporting membranes between each pair of the modules, wherein each module comprises an anode and a cathode.

### BACKGROUND

An efficient method for production of hydrogen gas is electrolysis. In an electrolyzer, an ion conducting membrane is sandwiched between two electrodes, and a voltage is applied across the electrodes. The voltage results in water from the aqueous electrolyte being split into hydrogen and oxygen and a final separation of hydrogen gas and oxygen gas on opposite sides of the membrane.

Typical electrolyzers comprise a stack of membranes between pairs of electrodes with separators in between in order to increase output of hydrogen gas. The separators are typically provided in the form of bipolar plates, for example two separators combined into a bipolar plate, BPP. The bipolar plates are sandwiching the membrane electrode assemblies in between. The number of such modules as well as the areal size of such modules determine the possible production output at a given current per density in the cells. In order to control the temperature of the electrolyzer, the bipolar plates are advantageously provided as two-layer plates having an internal coolant compartment guiding coolant through the BPP. Examples are illustrated in US patent applications US2021/0234237 and US2021/0202963, where opposite separator plates are welded to each other.

For proper flow and diffusion of the gas away from the membrane, there are often provided gas diffusion layers between the membrane and the electrodes. Examples are illustrated in US2021/0234237. However, the more layers the electrolyzer cell comprises, the higher is the risk that components are moving relative to each other, which causes a reduction in efficiency or even malfunctioning of the electrolyzer. Accordingly, there is an interest in providing electrolyzer systems with high rigidity and sturdiness.

This problem has been recognized in the international patent application WO84/03523. It discloses an arrangement of modules that sandwich membranes in between, where the modules comprise electrodes and separators fixed to each other. Two opposite separators are held in shape by an intermediate rigid, solid material to which the separators are affixed. By using a solid and rigid material in between the separators, it is not possible to use the separators as a bipolar plate with cooling channels inside. Accordingly, this disclosure only solves a partial problem of providing rigid and sturdy electrolyzer modules but does not include a solution to the problem of temperature control.

Chinese utility model CN212476910U discloses an electrolyzer for production of hydrogen gas comprising a stack of modules sandwiching ion-transporting membranes between each pair of the modules. Each module comprises a cathode chamber and an anode chamber and respective outlet holes as well as a plurality of liquid inlets in the middle part of the electrolysis chamber.

Further principles for electrolyzers are disclosed in Chinese utility models CN211455844U, CN205676538U, and CN209329036U.

JPS5871382A discloses a four-layer arrangement of separators and electrodes, where the four metallic components are welded together in a way where two corrugated separators are welded to each other and the protrusions on each side of the corresponding BPP are holding an electrode. Opposite ends of the pairs of corrugated separator sheets are open so that electrolyte is flowing into the space between the separator plates. Accordingly, there are no cooling channels through the bipolar plate.

As it appears from the above, several different attempts have been made to provide rigidity in modules of electrolyzers but there is still room for improvement. The latter is important as there is a continuous aim to improve quality and efficiency of electrolyzers.

### BRIEF DESCRIPTION

It is therefore an objective of the present systems and methods to provide an improvement in the art. In particular, it is an objective to provide an electrolyzer with a high degree of operational reliability. Furthermore, it is an objective to provide an electrolyzer with a plurality of separator/electrode modules that sandwich membranes in between, where the modules are rigid and suitable for mass production at relatively low cost and which allow for good temperature control of the electrolyzer. These objectives and further advantages are achieved with an electrolyzer as described below and in the claims.

In an embodiment, an electrolyzer comprises modules that sandwich ion-transporting membranes in between adjacent modules. The modules are formed as four-layer structures of four metal plates, typically steel plates, including two separator plates combined into a BPP and an anode plate and a cathode plate respectively on opposite sides of the BPP. The four plates are welded together to form a rigid module with three separate compartments, which are one anode compartment, one cathode compartment and a coolant compartment.

The electrolyzer is used for production of hydrogen gas. However, due to the splitting of water in the electrolyte when applying electrical power, also oxygen is produced. The hydrogen is collected for later use, for example in fuel cells or industrial applications.

In an embodiment, an electrolyzer comprises a stack of modules. Each pair of the consecutively arranged modules is sandwiching an ion-transporting membrane through which the respective ions are transported, for example OH⁻ ions from a KOH based electrolyte.

Each module comprises a first metal plate, which is a cathode plate, a second metal plate, which is an anode plate, and third and fourth metal plates which are first and second separator plates and which in combination form a two-layer bipolar plate, BPP, located in between the anode plate and the cathode plate. The four metal plates are welded together to form a rigid four-layer module with an outer anode side and an outer cathode side, opposite the anode side. The four plates form three compartments in between the plates, namely a first compartment, which is a cathode compartment between the cathode plate and the first separator plate and containing electrolyte, a second compartment, which is an anode compartment, between the anode plate and the second separator plate and containing electrolyte, and a third compartment between the first and second separator plates, which is a coolant compartment with a liquid-coolant flow path inside the two-layer BPP and which contains coolant. The coolant is different from electrolyte, and optionally contains glycol or is oil-based. Due to the BPP between the anode plate and the cathode plate, the coolant compartment is tightly separated from the anode compartment and from the cathode compartment.

For supply of water to the anode compartment and the cathode compartment in order to replenish consumed water, the module comprises an inlet for supplying water for the electrolysis in pure form or as part of replenished electrolyte. An option is a single water inlet from a common water supply conduit, which is sufficient for providing water for the electrolysis to both the anode and the cathode compartment. However, in some cases, it is also possible to provide more than one inlet, for example two inlets.

Optionally, water for the electrolysis is supplied to the chambers as part of replenished electrolyte solution. In this case, new electrolyte is replenished through the inlet and used electrolyte extracted through an outlet, which allows a circulation of the electrolyte and possible cleaning thereof. During the circulation of the electrolyte, the water concentration in the electrolyte is adjusted by adding water to the electrolyte in the circuit portion outside the electrolysis chambers. This facilitates optimization of the water concentration in the electrolyte. Optionally, the gas outlets are also used as outlets for the electrolyte, after which the electrolyte is separated from the gases and recirculated.

The oxygen gas produced at the anode is released from the anode compartment through an oxygen-gas outlet. A hydrogen gas outlet releases hydrogen gas from the cathode compartment. A flow of coolant through a coolant inlet, through the coolant compartment, and through a coolant outlet is used for controlling the temperature in the module and, thus, the temperature of the electrolyte and the electrodes.

The anode plate has anode perforations for providing electrolyte from the anode compartment to the membrane and flow of oxygen gas into the anode compartment.

Correspondingly, the cathode plate has cathode perforations for providing electrolyte from the cathode compartment to the membrane and flow of hydrogen gas into the cathode compartment.

In the middle of the four plates, the module has a central plane. Typically, the four plates are arranged in parallel and have a central plane parallel with the four plates.

In some practical embodiments, for providing tightness, the four metal plates are welded together along a closed curve, for example by a perimeter welding at the rim. Alternatively, the four metal plates are tightened along the perimeter or close to the perimeter by other means, such as glue or sealing gaskets.

In order to provide a high degree of rigidity, the plates are advantageously welded together at a plurality of interspaced further weldings. The plurality of further weldings is distributed across the plates within the perimeter and spaced from the perimeter and from each other for providing rigidity and for maintaining a predetermined distance between the plates. The weldings also provide a proper electrical contact between the plates. Each further welding extends over a local welding region and connects the corresponding welded plates across the local welding region. For example, the further weldings are provided near the center of the plates and between the center and the rim at selected positions. The positions are optionally chosen according to a regular pattern, for example a grid pattern with equal distance between adjacent further weldings.

For example, the further weldings connect all four plates across the local welding region.

Alternatively, the plates are only welded together pairwise, such that the cathode plate and the first separator plate are welded together at a plurality of interspaced further weldings, and the anode plate and the second separator plates are welded together at a plurality of interspaced further weldings, but the further weldings do not connect the two separator plates. In this case, optionally, both separator plates have multiple contact pressure regions at which the two separator plates are in contact with each other for securing good conductivity between the two separator plates and for maintaining a predetermined width of the coolant compartment. These contact pressure regions are not welded or otherwise fixed to each other, other than by pressure between the two separator plates.

Advantageously, in order to facilitate assembly and welding of the module at the further weldings, the pairs of plates or all four plates, are shaped with depressions that are abutting each other and with no spacing between the plates at and across the local welding regions before the welding. Thus, a welding of all four plates at the location of the local welding regions is a simple operation through the four tight-laid plates as these are already stacked tightly due to the depressions. As the depressions are provided by the corresponding plate's press-deformation prior to the welding and have a fixed distance between the bottom of the depression and the general plane of the plate, the depressions also define the final distance between adjacent plates. These achieved distances further define the widths of the corresponding compartments.

For example, the depressions in the anode plate and the cathode plate are deeper than the depressions of the separator plates. Optionally, in the case of the four plates being welded together, mutual abutment of the four plates at the welding region is provided centrally between the anode plate and the cathode plate.

The welding regions have a smallest dimension when measured in parallel with the central plane. Optionally, a smallest dimension of each of the welding regions is smaller than 5%, for example smaller than 2%, of a distance between two opposite edges at the rim. In other words, the welding regions are small as compared to the size of the plates. If the further weldings are circular, the dimensions in different directions are equal. But for elongate welding regions, for example oval, this is not the case, and the welding regions would have a smallest dimension, namely a width, and a largest dimension, namely a length. For such case of elongate local welding regions, in some embodiments, the welding regions have a largest dimension when measured in parallel with the central plane. In some embodiments, the largest dimension is smaller than 5%, for example smaller than 2%, of a distance between two opposite edges at the perimeter.

Optionally, for practical reasons, multiple further weldings are provided which are shaped identical.

In some practical embodiments, the oxygen gas outlet is provided as a canal with a canal perimeter along which all four plates are welded together to form a tight sealing between the plates. Advantageously, all of the four plates comprise circumferential deformation regions along the canal perimeter which are inclined towards the central plane for the plates to tightly abut each other along the canal perimeter. The circumferential deformation region of the anode plate comprises multiple oxygen outlet holes connecting the anode compartment with the oxygen canal for flow of oxygen from the anode compartment into the oxygen canal.

Similarly, as an option, the hydrogen gas outlet is provided as a canal with a canal perimeter along which all four plates are welded together to form a tight sealing between the plates. For example, all of the four plates comprise circumferential deformation regions along the canal perimeter which are inclined towards the central plane for the plates to tightly abut each other along the canal perimeter, and the circumferential deformation region of the cathode plate comprises multiple hydrogen outlet holes connecting the cathode compartment with the hydrogen canal for flow of hydrogen from the cathode compartment into the hydrogen canal.

Following such principle, the coolant inlet and/or the coolant outlet comprise a coolant canal with a canal perimeter along which the cathode plate and the adjacent first separator plate are welded together to form a tight sealing between the cathode compartment and the coolant compartment. Furthermore, along the canal perimeter of the coolant canal, the anode plate and the adjacent fourth plate are welded together to form a tight sealing between the anode compartment and the coolant compartment. For example, at the canal perimeter of the coolant canal, an opening is provided between the third and the fourth plate, which are the two separator plates of the BPP, as a flow path for flow of coolant between the coolant canal and the coolant compartment.

In some embodiments, the anode side and/or the cathode side is abutting the membrane in a zero-gap configuration. This means that the module is abutting the membrane.

For example, the perforations through the cathode plate from the cathode compartment to the membrane in total adds up to an open relative area A at the membrane of 20-50% of the total area by which the cathode abuts the membrane. Optionally, the perforations are provided as circular holes, for example having a diameter not smaller than the thickness of the cathode plate but not larger than 2 times the thickness of the cathode plate. For example, in a cathode plate with a thickness of 0.5 mm, the holes have a minimum diameter of 0.5 mm and an optional size in the range of 0.5-0.6 mm.

An example illustrates the advantage of these limits. For example, the open area of the perforations is 30% of the plate. A hole with a diameter of 2 mm has a surface area on the order of 3 mm². If the plate has a thickness of 1.5 mm, the hole forms a canal having a surface area of the circumference multiplied by the plate thickness, which makes up about 9 mm². Thus, the active area that is involved in the electrolysis is actually larger than the open area of the perforation itself. Until a certain thickness of the electrode plate, a thicker plate may result in higher hydrogen production yield than a thinner plate, however, having in mind that the electrical field quickly decreases with distance from the opposite electrode. This simple example also illustrates that many small perforations yield a higher production rate that few large openings, due to the added effect from the rim of the perforations.

As an option, similar to the above-described example, the perforations through the anode plate from the anode compartment to the membrane in total adds up to an open relative area at the membrane of 20-50% of the total area by which the anode abuts the membrane. As a further option, the perforations are provided as circular, for example having a diameter not smaller than the thickness of the anode plate but not larger than 2 times the thickness of the anode plate. For example, in an anode plate with a thickness of 0.5 mm, the holes have a minimum diameter of 0.5 mm and an optional size in the range of 0.5-0.6 mm.

In some embodiments, metal pressed-out sections are connected to rim portions of the perforations of the cathode plate and extend out of the plane of the cathode plate towards the adjacent separator plate, which is the third plate. Optionally, the pressed-out sections abut the third plate, which is used as a support to assist maintaining a constant distance between the cathode and the BPP. The sections also may assist in a good electrical contact between the plates. As a similar option, metal pressed-out sections are connected to rim portions of the perforations in the anode plate and extend out of the plane of the anode plate to the adjacent separator plate, which is the fourth plate, and abut the fourth plate as a support to assist maintaining a constant distance between the anode and the BPP. Optionally, the metal pressed-out sections are connected to two opposite rim portions of the perforations.

Typical dimensions are given in the following:
Thickness of plates: 0.5 mm to 2.5 mm
Length/width of the plates: 0.5 m to 3 m
Distance between electrode and BPP: 0.2 mm to 5 mm
Distance between separator plates of BPP: 1 mm to 10 mm

In some embodiments, the electrolyzer is part of a system in which the polarity of the power can be reversed, making the anode into a cathode and vice versa. Such periodic reversal prolongs the lifetime of the electrodes.

In some embodiments, the electrolyzer is part of a system in which the flow direction of the coolant through the BPP can be reversed, which may also prolong the lifetime.

### BRIEF DESCRIPTION OF THE DRAWINGS

The systems and methods will be explained in more detail with reference to the drawings, where

FIG. 1 is a sketch of an electrolyzer stack, according to an embodiment;

FIG. 2 illustrates an electrode/separator module in a head-on view, according to an embodiment;

FIG. 3 illustrates the four-layer principle of the module, according to an embodiment;

FIG. 4 illustrates a further welding, according to an embodiment;

FIG. 5 is a drawing with a perspective view of gas flow openings, according to an embodiment;

FIGS. 6A, 6B and 6C are drawings with A) a perspective view of coolant openings, B) a cross sectional view of coolant openings, and C) an optional embodiment with bridges between the openings, according to some embodiments;

FIGS. 7A and 7B illustrate a perforated electrode in A) a head-on view and B) enlarged perspective view, according to an embodiment;

FIGS. 8A and 8B illustrate a perforated electrode in A) a head-on view and B) enlarged perspective view, according to an embodiment;

FIGS. 9A and 9B illustrate a perforated electrode in A) perspective view and B) enlarged perspective view, according to an embodiment;

FIGS. 10A and 10B illustrate a perforated electrode in A) perspective view and B) enlarged perspective view, according to an embodiment;

FIG. 11 illustrates further welding regions connecting the plates pairwise, according to an embodiment.

### DETAILED DESCRIPTION

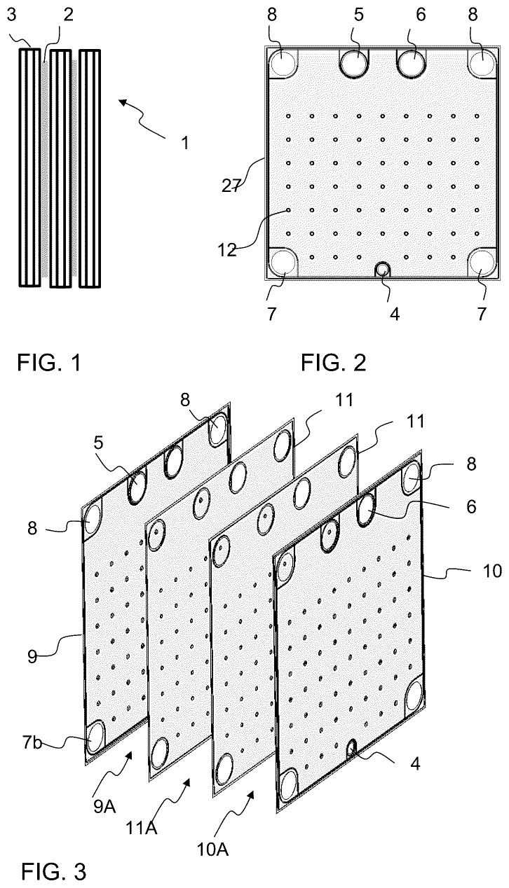

FIG. 1 is a sketch of a stacked electrolyzer 1 comprising ion-transporting membranes 2 sandwiched between electrode/separator modules 3.

The modules 3 contain the necessary electrolyte for the electrolytic reaction where water is split into oxygen and hydrogen. In order to replenish the water that is consumed during the reaction, the module 3 has a corresponding inlet 4, as illustrated in FIG. 2.

Optionally, the inlet 4 is used for supplying water in pure form into the modules 3 for the electrolysis or, alternatively, the inlet 4 is used for supplying water as part of replenished electrolyte. The modules also comprise a corresponding oxygen outlet 5 and hydrogen outlet 6. For temperature control and cooling purposes, the module 3 is equipped with coolant inlet 7 and coolant outlet 8.

FIG. 3 illustrates the four-layer principle of the module 3. The module comprises four sheets of metal, typically stainless steel, that are interconnected by weldings along the rim edges 27 and around the inlets 4, 7 and outlets 5, 6, 8. In the exploded view of FIG. 3, there is shown an anode 9, where oxygen is produced and released through oxygen outlet 5, and a cathode 10, where hydrogen is produced and released through hydrogen outlet 6. Two separator plates 11 form a bipolar plate, BPP, that mechanically separates the anode 9 and the anode compartment 9A from the cathode 10 and the cathode compartment 10A. However, the BPP electrically connects the anode 9 and the cathode 10, so that subsequent modules 3 of the stacked modules 3 with the membranes 2 in between the modules 3 stepwise increase the voltage along the stack.

To provide stiffness and stability and in order to provide a sturdy module, the further metal weldings 12, which are illustrated as point-like weldings but could have other shapes, are distributed all over most of the area of the module 3, as indicated in FIG. 2 and FIG. 3.

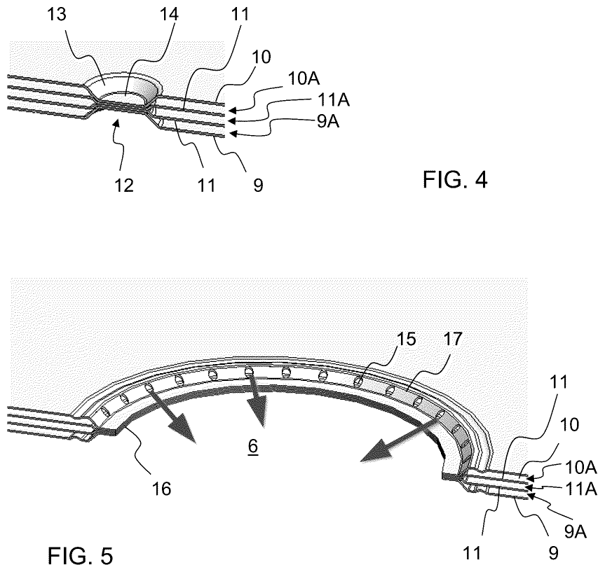

FIG. 4 illustrates a further welding 12. The further welding 12 comprises a local welding region 14. Around the welding region 14, the sheets of metal of the separators 11, the anode 9, and the cathode 10 have circular deformations 13 bending inwards towards the local welding region 14 for mutual common contact and where the welding is performed for fastening the four plates to each other.

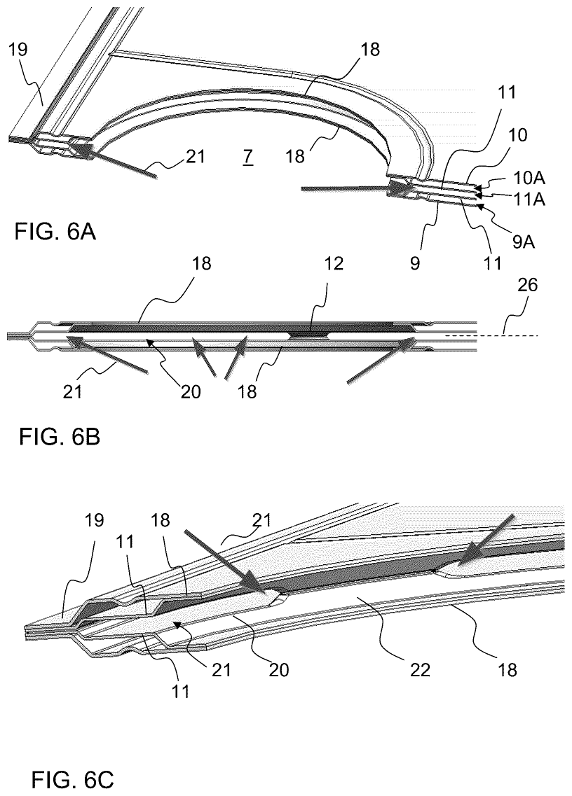

FIG. 5 is a drawing with a perspective view of gas flow openings 15 through which hydrogen gas is flowing into the hydrogen outlet 6. The flow openings are provided in a depression 17 towards the central plane 26 (illustrated in FIG. 6B) and along the perimeter of the canal of the hydrogen outlet 6. In extension thereof there is also provided a welding seam 16 that tightly connects the four plates, namely the two separator plates 11, the anode plate 9, and the cathode plate 10. A similar arrangement is optionally used for the flow of oxygen from the anode compartment 9A through the oxygen outlet 5 and into an oxygen canal.

FIG. 6A is a drawing with a perspective view of coolant openings and FIG. 6B is a cross sectional view of coolant openings 20 from coolant inlet 7 for flow 21 of coolant into the coolant compartment 11A between the two separator plates 11 that form the BPP between the anode 9 and the cathode 10. Around the coolant canal of the coolant inlet 7, there are provided tight weldings 18 that connect the first separator plate 11 with the cathode 10 and the second separator plate 11 with the anode 9. This ensures that no coolant flows into the anode compartment 9A or the cathode compartment 10A. Also seen in this drawing is one of the further weldings 12.

FIG. 6C illustrates an optional embodiment with mechanically stabilizing bridges 22 between the openings 20 from the coolant inlet 7 into the coolant compartment 11A. These mechanically stabilizing bridges 22 are provided by bending edges of the two separators 11 towards each other and welding them together. Similar arrangements can be used for the coolant outlets.

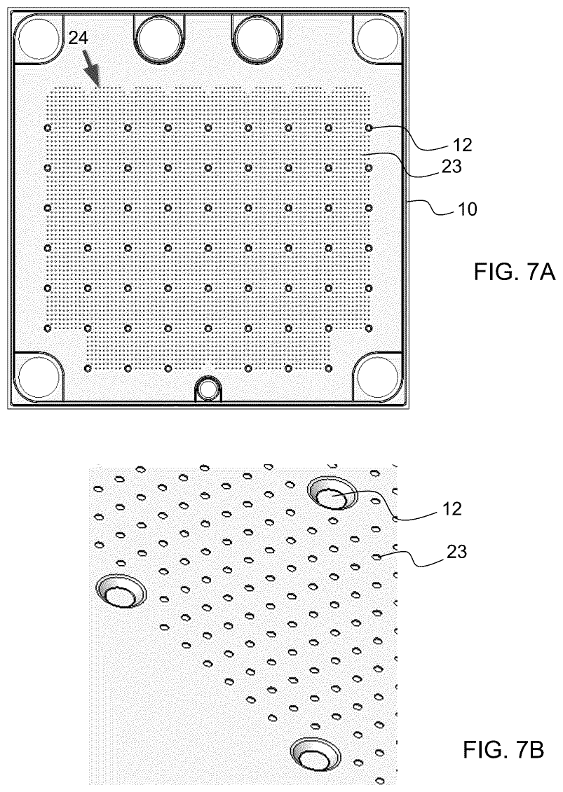

FIG. 7A illustrates a perforated electrode/separator module in a head-on view onto the cathode 10 and FIG. 7B is an enlarged perspective view. In this embodiment, the electrodes 9, 10 are abutting the corresponding membrane 2 in a zero-gap configuration. In order for the electrolyte, for example a KOH solution, to flow 24 to the membrane 2, the electrodes 9, 10 are provided with perforations 23. In the illustrated embodiments, the perforations 23 are circular openings through the electrode plate 10. As an example, the total free open area of the perforations 23, where the electrolysis takes place at the membrane 2, is on the order of 30% of the total area between the electrode 9, 10 and the membrane 2.

In practical embodiments, the hole diameter of 2 mm has been found useful. On the one hand, the diameter should not be too large because a large diameter results in a loss of active electrode surface area. On the other hand, too small diameters across the perforation 23 result in the perforation behaving like a narrow channel, perpendicular to the membrane 2, especially when the thickness of the electrode plate 9, 10 is larger than the diameter of the perforation 23, which in turn may lead to a reduced transport of gases sufficiently quickly away from the perforation 23.

Accordingly, the perforation 23 shape, size and the total area of the perforations, as well as the thickness of the electrode plates 9,10 influence the overall efficiency. For example, for circular openings with a diameter of 2 mm and a sheet thickness of 1.5 millimeters, the total surface area of the active electrode sheet material around the hole of the perforation is approximately 9 mm². Although, the electrical field decreases with distance from the membrane-facing edge of the perforation 23 towards the compartment side of the perforation, the total area that is active for the electrolysis with still reasonably high voltage is larger than the effective open area of the 2 mm perforation. All these factors have to be taken into account and balanced for an optimized efficiency.

This also implies that a reduction of the plate thickness of the electrodes 9, 10 for the same size of perforations, may result in a decreased total electrolysis efficiency of the module. However, on the other hand, thinner metal sheets used for electrodes and BPP in the module results in an overall smaller thickness of the module 3, and may allow a higher number of modules 3 to be stacked within the same container size of the electrolyzer and, thus, may still lead to higher overall efficiency of the stack per size unit of parameters.

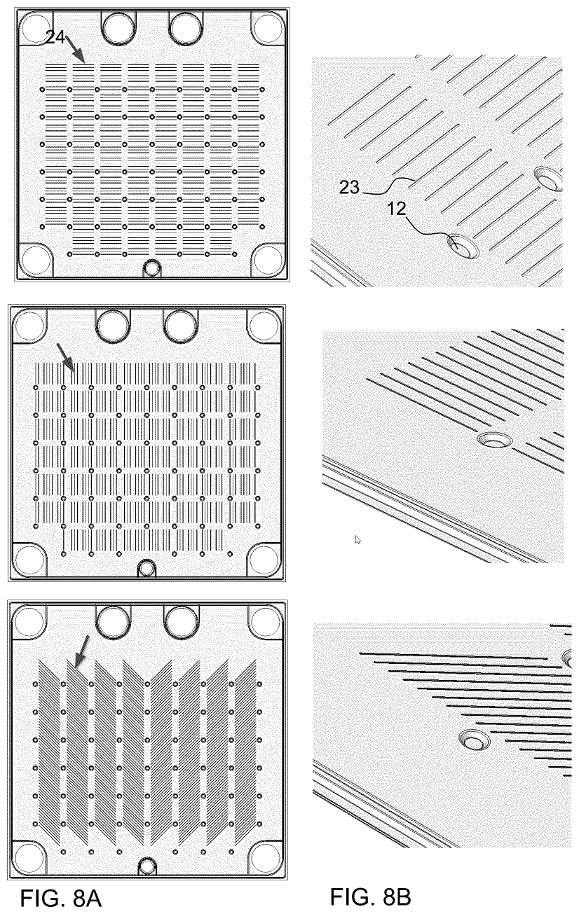

FIG. 8A illustrates different embodiments of perforated electrode/separator modules in a head-on view and FIG. 8B is an enlarged perspective view. In these shown cases, the perforations 23 are elongate openings formed as slits oriented in different directions, such as vertical, horizontal, inclined.

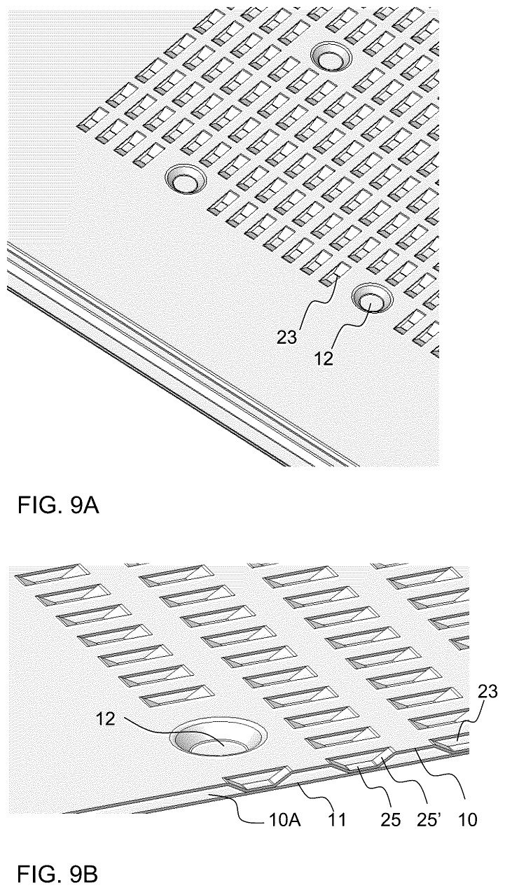

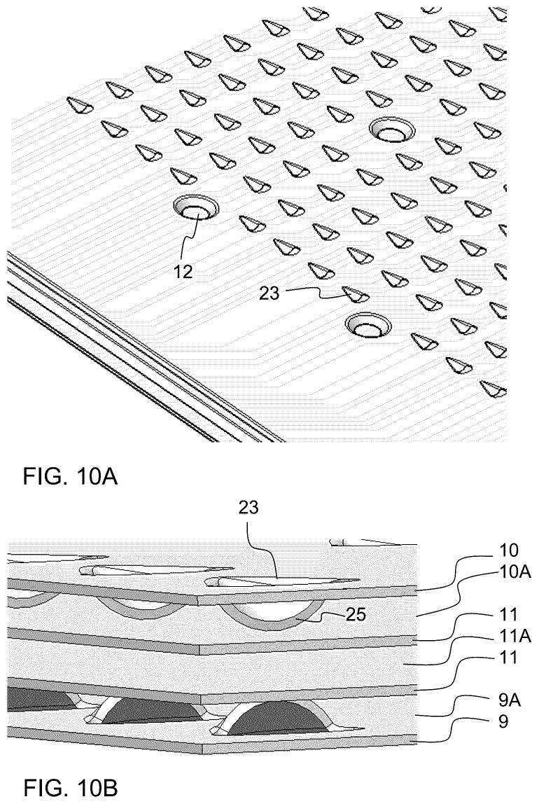

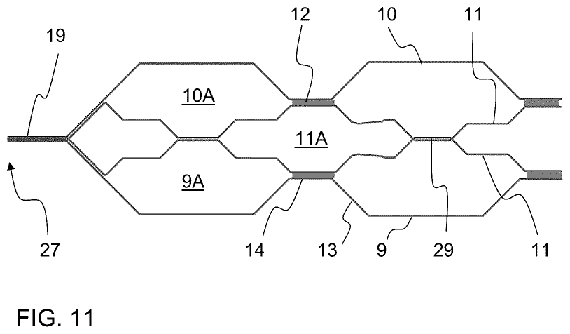

FIG. 9A illustrates a further embodiment of perforated electrode/separator modules in a perspective view and FIG. 9B is an enlarged perspective view. In the shown embodiment, the perforations 23 are provided by pressing small sections 25 of the electrode 10 out of the plane of the electrode 10. In the perforation industry, such types of perforations are also called bridge slot perforations. These displaced sections 25 connect to the adjacent separator plate 11 as a support, so that the sections 25 assist in maintaining a constant distance between the electrode, for example cathode 10 and/or anode 9, and the adjacent separator plate 11. Additionally, the sections 25 may assist in the electrical contact between the plates. The illustrated pressed-out metal sections 25 are connected to rim portions of the perforations 23. Although, the metal sections 25 are connected with connections 25′ to two opposite rim portions of the perforations 23, it is also possible that they are connected to only one rim portion of the perforation.

Whereas the pressed-out sections 25 for the perforations 23 in FIG. 9 have piece-wise straight portions for the connections 25′ that are mutually angled, the perforations 23 in FIG. 10A and FIG. 10B are curved. Also in this case, the pressed-out sections 25 are used for maintaining a constant distance between the electrodes 9, 10 and the adjacent separator plate 11, following a similar principle as that illustrated in FIG. 9.

FIG. 11 illustrates a further embodiment, in which all four plates 9, 10, 11 are welded together along the rim edge 27 by a four-layer perimeter welding 19. The cathode 10 and the first separator plate 11 are welded together at further welding regions 12, which are two-layer weldings. Furthermore, the anode 9 and the second separator plate 11 are welded together at even further welding regions 12, which are also two-layer weldings. Both separator plates 11 have multiple contact pressure regions 29, at which the separator plates 11 are in contact with each other for securing good conductivity between plates 11, but which are not welded or otherwise fixed to each other, other than by pressure.

What is claimed is:

1. An electrolyzer for production of hydrogen gas by electrolysis, the electrolyzer comprising:
a stack of modules sandwiching ion-transporting membranes between each pair of the modules, wherein each module comprises:
a first metal plate, which is a cathode plate;
a second metal plate, which is an anode plate;
an inlet for supplying water to an anode compartment and a cathode compartment;
an oxygen gas outlet for release of oxygen from the anode compartment; and
a hydrogen gas outlet for release of hydrogen gas from the cathode compartment;
a third metal plate and a fourth metal plate which are first and second separator plates and which in combination form a two-layer bipolar plate, BPP, located in between the anode plate and the cathode plate;
wherein the first, second, third and fourth metal plates are welded together to form a rigid four-layer arrangement of the module with an outer anode side and an outer cathode side, opposite the outer anode side, and with three compartments in between the plates, the three compartments being:
a first compartment, which is the cathode compartment between the cathode plate and the first separator plate and containing electrolyte;
a second compartment, which is the anode compartment, between the anode plate and the second separator plate and containing electrolyte; and
a third compartment between the first and the second separator plates, which is a coolant compartment with a liquid-coolant flow path inside the two-layer BPP, the third compartment containing coolant that is different from electrolyte, wherein the coolant compartment is separated from the anode compartment and the cathode compartment;
a coolant inlet and a coolant outlet for flow of coolant through the coolant compartment; wherein the coolant inlet and the coolant outlet comprise a coolant canal with a canal perimeter along which cathode sealing between the cathode compartment and the coolant compartment and along which the anode plate and the fourth metal plate are welded together to form a tight seal between the anode compartment and the coolant compartment;
wherein the anode plate has anode perforations for flow of the electrolyte from the anode compartment through the anode perforations to a membrane and for flow of oxygen through the anode perforations into the anode compartment, and wherein the cathode plate has cathode perforations for flow of the electrolyte from the cathode compartment through the cathode perforations to the membrane and flow of the hydrogen gas through the cathode perforations into the cathode compartment.

2. The electrolyzer according to claim 1, wherein the first, second, third and fourth metal plates are welded together along their perimeter by a perimeter welding.

3. The electrolyzer according to claim 1, wherein the cathode plate and the first separator plate are welded together at a plurality of interspaced further weldings, wherein the anode plate and the second separator plate are welded together at a plurality of interspaced further weldings, and wherein each further welding extends over a local welding region, wherein a plurality of the local welding regions is distributed across the plates within a perimeter of the plates and spaced from the perimeter and from each other for providing rigidity and for maintaining a predetermined distance between the plates that are welded together.

4. The electrolyzer according to claim 3, wherein the further weldings do not connect the first and second separator plates, wherein the first and second separator plates have multiple contact pressure regions at which the first and second separator plates are in contact with each other for ensuring good conductivity between the first and second separator plates, wherein the contact pressure regions are not permanently fixed to each other.

5. The electrolyzer according to claim 3, wherein the further weldings connect all of the first, second, third and fourth plates across the local welding region.

6. The electrolyzer according to claim 5, wherein the first, second, third and fourth plates at the further weldings form depressions with no spacing between the first, second, third and fourth plates at and across the local welding region.

7. The electrolyzer according to claim 6, wherein the depressions in the anode plate and the cathode plate are deeper than the depressions of the first and second separator plates.

8. The electrolyzer according to claim 3, wherein the module has a central plane parallel with the first, second, third and fourth plates and wherein the welding regions have a smallest dimension when measured parallel with the central plane, wherein the smallest dimension of each of the welding regions is smaller than 5% of a distance between two opposite edges at the perimeter.

9. The electrolyzer according to claim 8, wherein the welding regions have a largest dimension when measured parallel with the central plane, wherein the largest dimension is smaller than 5% of a distance between two opposite edges at the perimeter.

10. The electrolyzer according to claim 3, wherein the welding regions of the plurality of further weldings are shaped identically.

11. The electrolyzer according to claim 1, wherein at least one of the anode side and the cathode side is abutting the membrane in a zero-gap configuration.

12. The electrolyzer according to claim 1, wherein the oxygen gas outlet is provided as an oxygen canal with a welded canal perimeter along which all of the first, second, third and fourth plates are welded together to form a tight seal therebetween, and wherein all of the first, second, third and fourth plates comprise circumferential deformation regions along the welded canal perimeter which are inclined towards a central plane to tightly abut each other along the welded canal perimeter, and wherein the circumferential deformation region of the anode plate comprises multiple oxygen outlet holes connecting the anode compartment with the oxygen canal for flow of oxygen from the anode compartment into the oxygen canal, and/or wherein the hydrogen gas outlet is provided as a hydrogen canal with a welded canal perimeter along which all of the first, second, third and fourth plates are welded together to form a tight seal therebetween, and wherein all of the first, second, third and fourth plates comprise circumferential deformation regions along the welded canal perimeter which are inclined towards the central plane to tightly abut each other along the welded canal perimeter, and wherein the circumferential deformation region of the cathode plate comprises multiple hydrogen outlet holes connecting the cathode compartment with the hydrogen canal for flow of hydrogen from the cathode compartment into the hydrogen canal.

13. The electrolyzer according to claim 1, wherein an opening is provided between the third plate and the fourth plate at the canal perimeter of the coolant canal as a flow path for flow of coolant between the coolant canal and the coolant compartment.

14. The electrolyzer according to claim 1, wherein the cathode perforations through the cathode plate from the cathode compartment to the membrane in total adds up to an open relative area at the membrane of 20-50% of a total area by which the cathode plate abuts the membrane.

15. The electrolyzer according to claim 14, wherein the cathode perforations are provided as circular holes having a diameter not smaller than a thickness of the cathode plate but not larger than 2 times the thickness of the cathode plate.

16. The electrolyzer according to claim 1, wherein metal sections are pressed out of the cathode plate and connected to rim portions of the cathode perforations and extend out of a plane of the cathode plate to the third plate, which is an adjacent one of the first and second separator plates, and abut the third plate as a support to assist maintaining a constant distance between the cathode plate and the third plate and/or wherein metal sections are pressed out of the anode plate and are connected to rim portions of the anode perforations in the anode plate and extend out of a plane of the anode plate to the fourth plate and abut the fourth plate as a support to assist maintaining a constant distance between the anode plate and the fourth plate.

17. The electrolyzer according to claim 16, wherein the pressed out metal sections are connected with connections to two opposite rim portions.

18. The electrolyzer according to claim 1, wherein the water is in pure form.

19. The electrolyzer according to claim 1, wherein the water is part of the electrolyte.
